(19) United States
(12) Patent Application Publication
(10) Pub. No.: US 2026/0355997 A1
(43) Pub. Date: Nov. 12, 2026

(54) APPARATUS FOR PUNCHING A PART FROM A WEB AND LOCATING IT ON A COMPONENT

(71) Applicant: Nicoventures Trading Limited, London (GB)

(72) Inventors: Arnold HERHOLDT, London (GB); Dirk SWART, London (GB)

(21) Appl. No.: 19/488,509

(22) PCT Filed: May 30, 2024
(86) PCT No.: PCT/GB2024/051397

§ 371 Date: Nov. 26, 2025

(30) Foreign Application Priority Data
May 31, 2023 (GB) 2308149.0

(51) Int. Cl. B26F 1/40; A24F 40/70; B26F 1/44

(52) U.S. Cl. CPC B26F 1/40; B26F 1/44; A24F 40/70; B26F 2001/4481

(57) ABSTRACT

An apparatus for forming a cut portion of sheet material and locating the cut portion of sheet material in a component for use in a delivery system is disclosed. The apparatus comprises a reel to supply sheet material, a tensioning system configured to tension a portion of the sheet material, and a punch configured to cut the cut portion of sheet material from the tensioned portion of sheet material and to locate the cut portion of sheet material within the component of the delivery system. A method of forming a cut portion of sheet material and locating the cut portion of sheet material in a component for use in a delivery system is also disclosed.

### CROSS-REFERENCE TO RELATED APPLICATIONS

This present application is a National Phase entry of PCT Application No. PCT/GB2024/051397, filed May 30, 2024, which claims priority from Great Britain Application No. 2308149.0, filed May 31, 2023, each of which are fully incorporated herein by reference in their entireties.

### FIELD

The present invention relates to an apparatus and a method for forming a cut portion of sheet material and locating said cut portion of sheet material in a component for use in a delivery system.

### BACKGROUND

There exists a need to provide an apparatus and a method for the efficient manufacture of components for delivery systems which may involve supplying a continuous sheet material; tensioning a portion of the sheet material; cutting the cut portion of sheet material from the tensioned portion of sheet material, and locating the cut portion of sheet material within the component for use in a delivery system. These, and other manufacturing steps, may need to be carried out on a plurality of components in quick succession.

### SUMMARY

According to the present disclosure, there is provided an apparatus for forming a cut portion of sheet material and locating said cut portion of sheet material in a component for use in a delivery system, the apparatus comprising: a reel to supply sheet material; a tensioning system configured to tension a portion of the sheet material; and a punch configured to cut said cut portion of sheet material from the tensioned portion of sheet material and to locate the cut portion of sheet material within said component of the delivery system.

The apparatus may further comprise a machine tray support for locating a machine tray of components, the components may be arranged in an array in the machine tray.

The tensioning system may be moveable between a first position and a second position. The apparatus may be configured so that, when a machine tray is located within the machine tray support, the tensioned portion of sheet material is disposed over a first row of the array of components in the machine tray when the tensioning system is in the first position and disposed over a second row of the array of components in the machine tray when the tensioning system is in the second position.

The punch may be configured to cut the tensioned portion of sheet material when the tensioning system is in either the first position or the second position.

The punch may be moveable in a vertical plane between a start position, in which the punch may be configured to allow the insertion or removal of the machine tray from the machine tray support, and an end position in which the punch may be configured to engage the machine tray.

The punch may comprise a punch plate and an array of protrusions that depend from a bottom surface of the punch plate. The apparatus may be configured so that, when a machine tray is located within the machine tray support, each protrusion of said array of protrusions is associated with a corresponding component of the machine tray.

The array of protrusions may comprise a row of protrusions configured to punch multiple cut portions of sheet material from the supply of sheet material.

Each protrusion may comprise a concave end face.

The punch may comprise a clamp plate and a die plate. The punch may be configured to clamp the tensioned portion of sheet material between said clamp plate and die plate.

The clamp plate may comprise an aperture to allow the punch plate to move through the clamp plate.

The die plate may comprise a plurality of through-holes, each through-hole corresponding with one of the array of protrusions of the punch and configured to receive the protrusion when the punch is in the end position.

The apparatus may comprise a track for guiding the machine tray into the machine tray support.

The apparatus may comprise the machine tray and the machine tray may comprise a pair of cam followers configured to interact with the track to retain and direct the machine tray along the track.

The pair of cam followers may each comprise a spring arranged to suspend a component holding plate of the machine tray above the track.

The machine tray support may comprise an anvil on which the component holding plate is supported when the punch is in the end position.

The spring of each cam follower may be at least partially compressed when the punch is in the end position.

The punch may further comprise a carrier plate moveable in the vertical plane. The punch plate may be fixed to the carrier plate beneath the carrier plate. The clamp plate may be slidably suspended from the carrier plate by a suspending rod.

The apparatus may be configured so that when the punch moves between the start position and the end position: the carrier plate, punch plate and clamp plate move toward the die plate; the tensioned portion of sheet material is clamped between the clamp plate and the die plate; and the punch plate moves through the aperture in the clamp plate to cut the tensioned portion of sheet material against the die plate.

The die plate may be suspended beneath the carrier plate by the suspending rod.

The apparatus may be configured so that when the punch moves between the start position and the end position and the machine tray is located in the machine tray support, the die plate moves from a first position, in which the die plate is spaced from the machine tray, to a second position in which the die plate contacts the machine tray. The die plate may comprise a plurality of locating pins configured to mate with a plurality of locating holes in the machine tray when die plate is in the second position.

The punch plate may comprise a plurality of locating pins configured to mate with a plurality of locating holes in the die plate when the punch is in the end position.

The supply of sheet material may comprise a first sheet of material and a second sheet of material running parallel to one another.

The array of protrusions of the punch may comprise multiple rows of protrusions, each row may be configured to punch a different sheet of material.

The tensioning system may comprise a pair of bobbins and a plurality of rollers configured to feed the first and second sheets of material through the punch and to generate tension in the tensioned portion of sheet material.

According to another aspect of the present disclosure, there is provided a method of forming a cut portion of sheet material and locating said cut portion of sheet material in a component for use in a delivery system, the method comprising: supplying a continuous sheet material via a reel; tensioning a portion of the sheet material via a tensioning system; cutting said cut portion of sheet material from the tensioned portion of sheet material via a punch, and locating said cut portion of sheet material within the component for use in a delivery system.

The method may comprise moving the tensioning system from a first position to a second position.

The method may comprise a second cutting step once the tensioning system has been moved from the first position to the second position.

Cutting said cut portion of sheet material from the tensioned portion of sheet material may comprise actuating a punch in a vertical plane between a start position, in which a punch plate is spaced from the tensioned portion of sheet material, and an end position in which the punch plate is configured to cut the tensioned portion of sheet material.

The method may comprise clamping the tensioned portion of sheet material between a clamp plate and a die plate.

The method may comprise guiding a machine tray comprising a plurality of components for use in delivery systems such that the machine tray rests beneath the die plate.

The method may comprise actuating the die plate and clamp plate in a vertical plane in a direction towards the machine tray such that the tensioned portion of sheet material is clamped prior to moving the punch plate into interfacing relation with the die plate.

### BRIEF DESCRIPTION OF THE DRAWINGS

Embodiments of the invention will be described, by way of example only, with reference to the accompanying drawings, in which:

FIGS. 1A and 1B show an isometric and exploded view respectively of a component for use in a delivery system;

FIG. 2 shows an apparatus according to an embodiment of the invention;

FIG. 3 shows a schematic diagram of a punch plate according to an embodiment of the invention;

FIGS. 4A and 4B show front schematic diagrams of the apparatus according to an embodiment of the invention with the punch in the first position and the second position respectively;

FIG. 5 shows a side-on view of the machine tray according to an embodiment of the invention; and

FIG. 6 shows a diagram of method steps of a method according to an embodiment of the invention.

### DETAILED DESCRIPTION

As used herein, the term “delivery system” is intended to encompass systems that deliver at least one substance to a user, and includes: combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material); non-combustible aerosol provision systems that release compounds from an aerosol-generating material without combusting the aerosol-generating material, such as electronic cigarettes, tobacco heating products, and hybrid systems to generate aerosol using a combination of aerosol-generating materials; and aerosol-free delivery systems that deliver the at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thp thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

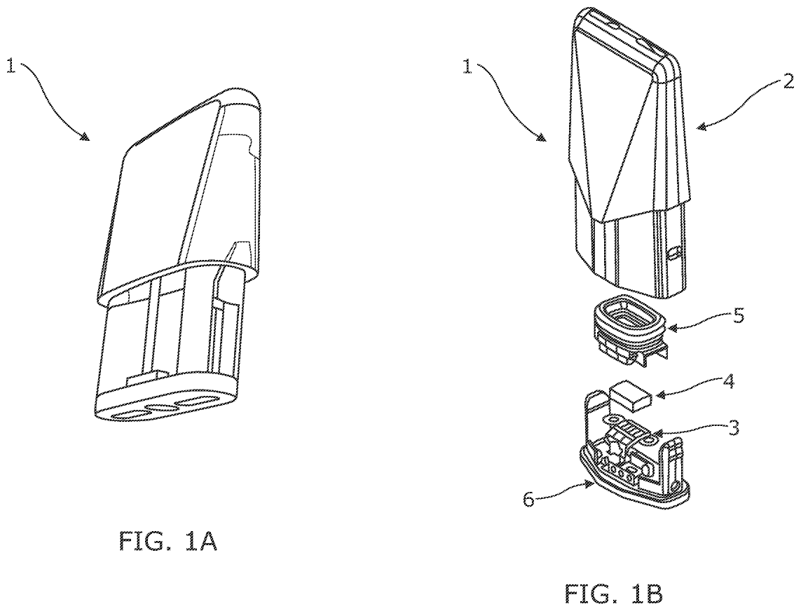

FIGS. 1A and 1B illustrate a component 1 for use in a delivery system (not shown). As shown in FIG. 1A, the component 1 is a mouthpiece assembly that is configured to be attachable to a main body of a delivery system. For example, the delivery system is a non-combustible aerosol provision device, having a main body that typically comprises a battery. As shown in FIG. 1B, the component comprises a mouthpiece 2, a heater 3, a wick 4, a heater support 5 and an end cap 6.

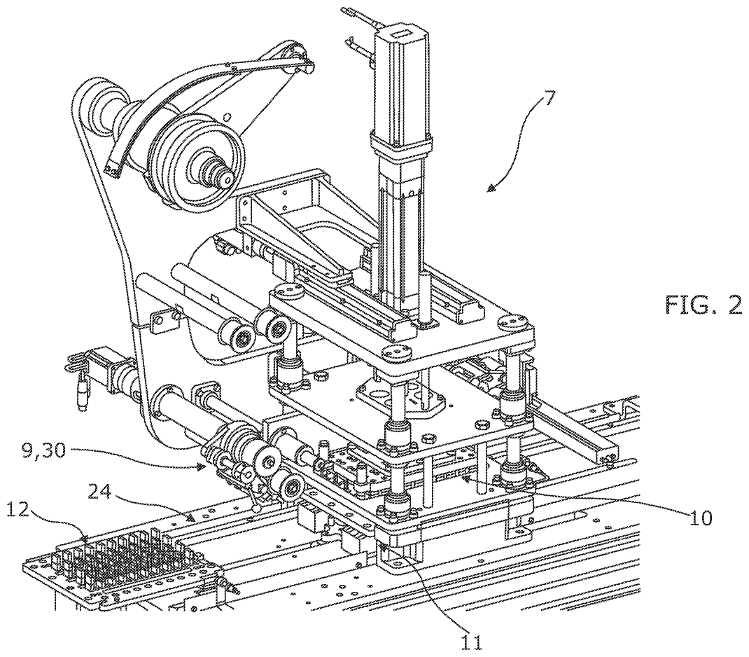

FIG. 2 illustrates an apparatus 7 according to an embodiment of the invention for forming a cut portion of sheet material and for locating the cut portion of sheet material in a component for use in a delivery system. The cut portion of sheet material corresponds to the wick 4 of the mouthpiece assembly 1 shown in FIG. 1B.

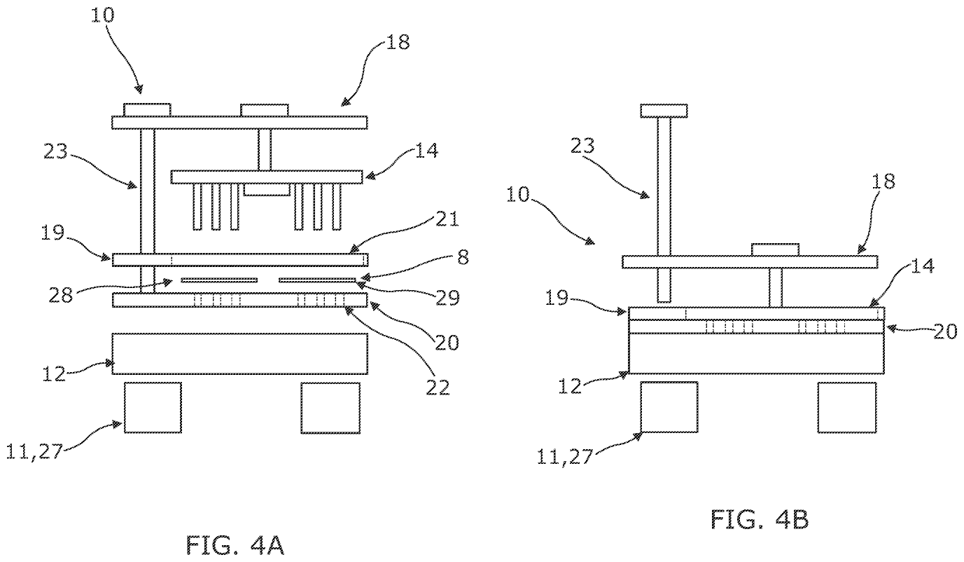

The apparatus 7 comprises a reel configured to supply sheet material 8 (the sheet material being shown in FIGS. 4A and 4B) and a tensioning system 9 configured to tension a portion of the sheet material 8. In some embodiments, the sheet material may be a non-woven sheet material, such as cotton. It is to be appreciated that the sheet material may alternatively be any other form of sheet material which may be fed through the apparatus such as paper, plastic, etc. Additionally, the apparatus 7 comprises a punch 10 configured to cut the cut portion of sheet material 8 from the tensioned portion of sheet material 8 and to locate the cut portion of sheet material 8 within the component 1 of the delivery system.

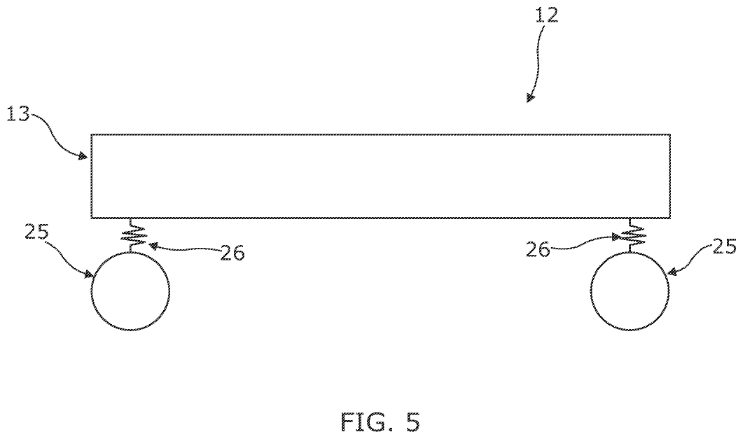

As shown in FIG. 2, the apparatus 7 comprises a machine tray support 11, for locating a machine tray 12 of components 1 beneath the punch 10. The machine tray 12 comprises a component holding plate 13 (shown in FIG. 5) configured to retain the components 1 in position on the machine tray 12. In some embodiments, the components 1 are arranged in an array comprising a first row and a second row of components. However, it is to be appreciated that in other embodiments, the machine tray 12 comprises a different arrangement, for example the array may consist of four rows of ten components. The components 1 may be arranged in the machine tray 12 in any desired number of rows with any desired number of components forming each row.

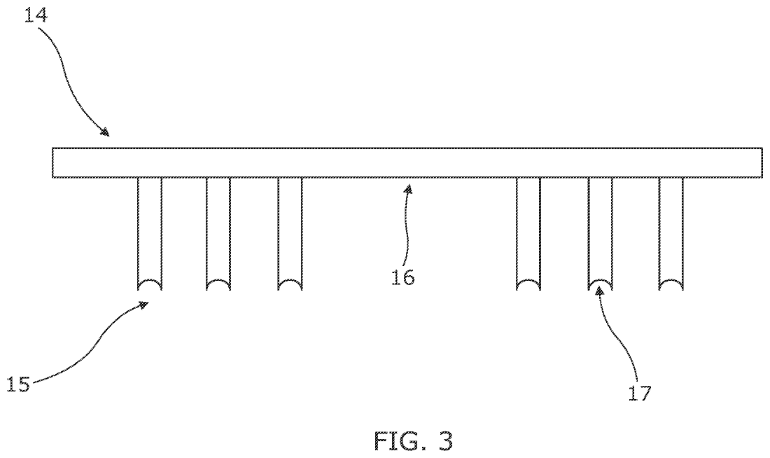

The punch 10 is moveable in a vertical plane between a start position and an end position. FIG. 3A illustrates a schematic diagram of the apparatus 7 when the punch 10 is in the start position and FIG. 3B illustrates a schematic diagram of the apparatus 7 when the punch 10 is in the end position. In the start position, the punch 10 is spaced from the machine tray support 11 and is thus configured to allow the insertion or removal of a machine tray 12 from the machine tray support 11. In the end position, the punch 10 is configured to engage the machine tray 12. As the punch 10 moves from the start position to the end position, the punch 10 is configured to cut the cut portion of sheet material 8 from the tensioned portion of sheet material 8 and to locate the cut portion of sheet material 8 in the components 1 for use in a delivery system arranged in the machine tray 12.

The punch 10 comprises a punch plate 14 which is illustrated in FIG. 3. As shown, an array of protrusions 15 depend from a bottom surface 16 of the punch plate 14. The protrusions 15 depending from the punch plate 14 are configured to cut the tensioned portion of sheet material 8 to form the cut portion of sheet material 8 and to locate the cut portion of sheet material 8 into the components 1 for use in a delivery system that are arranged in the array of the machine tray 12. The array of protrusions 15 comprises a row of protrusions configured to punch multiple cut portions of sheet material during one punching action. In some embodiments, the array of protrusions may comprise multiple rows of protrusions arranged to punch a plurality of sheets of material simultaneously. The apparatus 7 is configured so that when a machine tray 12 is located within the machine tray support 11, each protrusion of the array of protrusions 15 depending from the punch plate 14 is associated with a corresponding component 1 in the array of the machine tray 12. As shown in FIG. 3, each protrusion depending from the punch plate 14 comprises a concave end face 17. Providing each protrusion with a concave end face reduces the pressure exerted on the tensioned sheet material when the protrusions come into contact with the sheet material.

As shown in FIGS. 4A and 4B, in addition to the punch plate 14 the punch 10 comprises a carrier plate 18, a clamp plate 19 arranged beneath the carrier plate and a die plate 20 arranged beneath the clamp plate 19. The punch plate 14 is fixed to the carrier plate 18 beneath the carrier plate 18, i.e. the punch plate 14 is fixed to the underside of the carrier plate 18. The carrier plate 18 is moveable in the vertical plane and facilitates movement of the punch plate 14 between the start and end positions. The punch 10 is configured to clamp the tensioned portion of sheet material 8 between the clamp plate 19 and die plate 20 as the punch 10 moves from the start position to the end position. Due to the tensioned portion of sheet material 8 being clamped in place during cutting, the cutting action is more consistent. The clamp plate 19 comprises an aperture 21 to allow the punch plate 14 to move through the clamp plate 19 and thus cut the clamped tensioned portion of sheet material 8. Additionally, the die plate 20 comprises a plurality of through-holes 22. Each through-hole of the die plate 20 corresponds with one of the array of protrusions 15 of the punch plate 14 and is configured to receive the corresponding protrusion when the punch 10 is in the end position. In this way, the tensioned portion of sheet material 8 is sheared by the array of protrusions 15 as the protrusions enter the corresponding through-holes 22 in the die plate 20 and the tensioned portion of sheet material 8 is cut. In other words, the apparatus 7 is configured so that when the punch 10 moves between the start position and the end position, the carrier plate 18, punch plate 14 and clamp plate 19 move towards the die plate 20. The tensioned portion of sheet material 8 is clamped between the clamp plate 19 and the die plate 20 and the punch plate 14 moves through the aperture 21 in the clamp plate 19 to cut the tensioned portion of sheet material 8 against the die plate 20.

As shown in FIGS. 4A and 4B, the clamp plate 19 is slidably suspended from the carrier plate 18 by a suspending rod 23 and the die plate 20 is suspended beneath the carrier 18 plate by the suspending rod 23. The apparatus 7 is configured so that when the punch 10 moves between the start position and the end position, and a machine tray 12 is located in the machine tray support 11, the die plate 20 moves from a first position (shown in FIG. 4A), in which the die plate 20 is spaced from the machine tray 12, to a second position (shown in FIG. 4B) in which the die plate 20 contacts the machine tray 12.

The die plate 20 is initially in the first position (FIG. 4A) where the die plate 20 is spaced from the machine tray 12. As the carrier plate 18 moves downwards, the die plate 20 also moves in a downward direction due to the connection to the carrier plate 18 via the suspending rod 23. Once the die plate 20 is in the second position (FIG. 4B) and is in contact with the machine tray 12, the die plate 20 is unable to continue to move in a downwards direction. The clamp plate 19 continues to move in a downward direction due to the connection to the carrier plate 18 via the suspending rod 23. The clamp plate 19 comes into contact with the tensioned portion of sheet material 8 and then with the die plate 20. In this position, the tensioned portion of sheet material 8 is clamped between the clamp plate 19 and die plate 20 and the clamp plate 19 is unable to continue moving in a downward direction. The punch plate 14 continues to move in a downward direction due to the fixed connection to the carrier plate 18. The punch plate 14 moves through the aperture 21 in the clamp plate 19, the array of protrusions 15 of the punch plate 14 co-operate with the through-holes 22 in the die 20 and the tensioned portion of sheet material 8 is cut. Each of the punch plate 14, clamp plate 19 and die plate 20 then moves in an upward direction until the die plate 20 is back in the first position and the punch 10 is back in the start position where another machine tray 12 can be loaded beneath the punch 10.

Furthermore, the die plate 20 comprises a plurality of locating pins (not shown). The locating pins depend from an underside of the die plate 20 and are configured to mate with a plurality of locating holes (not shown) in the machine tray 12 when the die plate 20 is in the second position (i.e., in contact with the machine tray). The locating pins on the die plate 20 interact with the locating holes in the machine tray 12 to ensure that the die plate 20 and machine tray 12 are in correct alignment with one another prior to the tensioned portion of sheet material 8 being cut.

Additionally, the punch plate 14 comprises a plurality of locating pins (not shown). The locating pins depend from an underside of the punch plate 14 and are configured to mate with a plurality of locating holes (not shown) in the die plate 20 when the punch 10 is in the end position (i.e., in contact with the die plate). The locating pins on the punch plate 14 interact with the locating holes in the die plate 20 to ensure that the punch plate 14 and die plate 20 are in correct alignment with one another as the tensioned portion of sheet material 8 is being cut.

Referring back to FIG. 2, the apparatus 7 comprises a track 24 for guiding the machine tray 12 into the machine tray support 11. In some embodiments, the apparatus 7 also comprises the machine tray 12.

As seen in FIG. 5, the machine tray 12 comprises a pair of cam followers 25 that are configured to interact with the track 24 to retain the machine tray 12 in position and to direct the machine tray 12 along the track 24. Each of the pair of cam followers 25 comprises a spring 26 that is configured to suspend the component holding plate 13 of the machine tray 12 above the track 24. When the punch 10 is in the end position the component holding plate 13 of the machine tray 12 is supported on an anvil 27 (shown in FIGS. 4A and 4B) of the machine tray support 11. The spring 26 of each cam follower 25 is at least partially compressed when the punch 10 is in the end position. This ensures that the machine tray 12 in not damaged when the punch 10 is in the end position.

Referring back to FIGS. 4A and 4B, the supply of sheet material 8 comprises a first sheet of material 28 and a second sheet of material 29 running parallel to one another. Additionally, the tensioning system 9 comprises a pair of bobbins (not shown) and a plurality of rollers 30 (shown in FIG. 2) configured to feed the first and second sheets of material 28, 29 through the punch 10 and to generate tension in the tensioned portion of sheet material 8. Here, as described above, the array of protrusions of the punch may comprise multiple rows of protrusions. Each row of the multiple rows of protrusions may be arranged to punch a separate supply of sheet material. For example, a first row of protrusions is arranged to punch the first sheet of material and the second row of protrusions is arranged to punch the second sheet of material. It is to be appreciated that the apparatus may be arranged such that the supply of sheet material comprises any number of sheets of material and that the array of protrusions of the punch may comprise any number of rows.

In some embodiments, the tensioning system 9 is movable between a first position and a second position. When the tensioning system 9 is in the first position, the apparatus 7 is configured so that when a machine tray 12 is located within the machine tray support 11, the tensioned portion of sheet material 8 is disposed over a first row of the array of components 1 in the machine tray 12. When the tensioning system 9 is in the second position, the apparatus 7 is configured so that when a machine tray 12 is located within the machine tray support 11, the tensioned portion of sheet material 8 is disposed over a second row of the array of components 1 in the machine tray 12. In this arrangement, the punch 10 is configured to cut the tensioned portion of sheet material 8 when the tensioning system 9 is in either the first position or the second position.

In some embodiments, the machine tray 12 comprises four rows of components 1 for use in a delivery system and the supply of sheet material 8 comprises the first sheet of material 28 and the second sheet of material 29. Initially, the tensioning system 9 is in the first position, the tensioned first sheet of material 28 is disposed over the first row of the array of components 1 in the machine tray 12 and the tensioned second sheet of material 29 is disposed over the third row of the array of components 1 in the machine tray 12. When the tensioning system 9 is in the second position, the tensioned first sheet of material 28 is disposed over the second row of the array of components 1 in the machine tray 12 and the tensioned second sheet of material 29 is disposed over the fourth row of the array of components 1 in the machine tray 12. In other words, the tensioning system 9 is initially located in the first position where the punch 10 is configured to cut and locate the cut portion of sheet material 8 into the first and third rows of the array of components 1 in the machine tray 12. The tensioning system 9 is then movable to the second position where the punch 10 is configured to cut and locate the cut portion of sheet material 8 into the second and fourth rows of the array of components 1 in the machine tray 12.

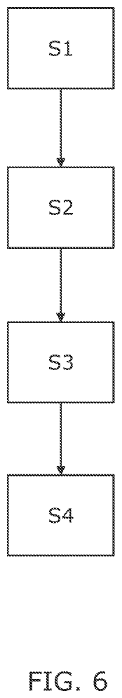

FIG. 6 shows a diagram illustrating a method, according to an embodiment of the invention, of forming a cut portion of sheet material and locating the cut portion of sheet material in a component for use in a delivery system. The method comprises a first step S1 of supplying a continuous sheet material and a second step S2 of tensioning a portion of the sheet material. Once the sheet material is under tension, the method comprises a third step S3 of cutting the portion of sheet material from the tensioned portion of sheet material and a fourth step S4 of locating the cut portion of sheet material within the component for use in a delivery system.

In some embodiments, the method comprises moving the tensioning system from a first position to a second position on the fourth step is complete. Additionally, in some embodiment, the method comprises a second cutting step once the tensioning system has been moved from the first position to the second position.

As explained above, cutting the cut portion of sheet material from the tensioned portion of sheet material comprises actuating a punch in a vertical plane between a start position, in which a punch plate is spaced from the tensioned portion of sheet material, and an end position in which the punch plate is configured to cut the tensioned portion of sheet material. Furthermore, the method comprises clamping the tensioned portion of sheet material between a clamp plate and a die plate.

In some embodiments, the method comprises guiding a machine tray comprising a plurality of components for use in delivery systems such that the machine tray rests beneath the die plate. Additionally, as explained above the method comprises actuating the die plate and clamp plate in a vertical plane in a direction towards the machine tray such that the tensioned portion of sheet material is clamped prior to moving the punch plate into interfacing relation with the die plate.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future

1. An apparatus for forming a cut portion of sheet material and locating said cut portion of sheet material in a component for use in a delivery system, the apparatus comprising:
a reel to supply sheet material;
a tensioning system configured to tension a portion of the sheet material; and
a punch configured to cut said cut portion of sheet material from the tensioned portion of sheet material and to locate the cut portion of sheet material within said component of the delivery system.

2. An apparatus according to claim 1, further comprising a machine tray support for locating a machine tray of components, the components being arranged in an array in the machine tray.

3. An apparatus according to claim 2, wherein the tensioning system is moveable between a first position and a second position, and wherein the apparatus is configured so that, when a machine tray is located within the machine tray support, the tensioned portion of sheet material is disposed over a first row of the array of components in the machine tray when the tensioning system is in the first position and disposed over a second row of the array of components in the machine tray when the tensioning system is in the second position and, wherein the punch is preferably configured to cut the tensioned portion of sheet material when the tensioning system is in either the first position or the second position.

4. (canceled)

5. An apparatus according to claim 2, wherein the punch is moveable in a vertical plane between a start position, in which the punch is configured to allow the insertion or removal of the machine tray from the machine tray support, and an end position in which the punch is configured to engage the machine tray.

6. An apparatus according to claim 2, wherein the punch comprises a punch plate and an array of protrusions that depend from a bottom surface of the punch plate, wherein each protrusion preferably comprises a concave end face, and wherein the apparatus is configured so that, when a machine tray is located within the machine tray support, each protrusion of said array of protrusions is associated with a corresponding component of the machine tray.

7. An apparatus according to claim 6, wherein the array of protrusions comprises a row of protrusions configured to punch multiple cut portions of sheet material from the supply of sheet material.

8. (canceled)

9. An apparatus according to claim 6, wherein the punch comprises a clamp plate and a die plate, the punch being configured to clamp the tensioned portion of sheet material between said clamp plate and die plate, and wherein the clamp plate preferably comprises an aperture to allow the punch plate to move through the clamp plate.

10. (canceled)

11. An apparatus according to claim 9, wherein the die plate comprises a plurality of through-holes, each through-hole corresponding with one of the array of protrusions of the punch and configured to receive the protrusion when the punch is in the end position.

12. An apparatus according to claim 2, wherein the apparatus comprises a track for guiding the machine tray into the machine tray support.

13. An apparatus according to claim 2, wherein the apparatus comprises the machine tray and the machine tray comprises a pair of cam followers configured to interact with the track to retain and direct the machine tray along the track, wherein the pair of cam followers preferably each comprise a spring arranged to suspend a component holding plate of the machine tray above the track.

14. (canceled)

15. An apparatus according to claim 13, wherein the machine tray support comprises an anvil on which the component holding plate is supported when the punch is in the end position, and wherein the spring of each cam follower is preferably at least partially compressed when the punch is in the end position.

16. (canceled)

17. An apparatus according to claim 9, wherein the punch further comprises a carrier plate moveable in the vertical plane, and wherein the punch plate is fixed to the carrier plate beneath the carrier plate; and wherein the clamp plate is slidably suspended from the carrier plate by a suspending rod, and wherein the die plate is preferably suspended beneath the carrier plate by the suspending rod.

18. An apparatus according to claim 17, wherein the apparatus is configured so that when the punch moves between the start position and the end position: the carrier plate, punch plate and clamp plate move toward the die plate; the tensioned portion of sheet material is clamped between the clamp plate and the die plate; and the punch plate moves through the aperture in the clamp plate to cut the tensioned portion of sheet material against the die plate.

19. (canceled)

20. An apparatus according to claim 9, wherein the apparatus is configured so that when the punch moves between the start position and the end position and the machine tray is located in the machine tray support, the die plate moves from a first position, in which the die plate is spaced from the machine tray, to a second position in which the die plate contacts the machine tray.

21. An apparatus according to claim 9, wherein the die plate comprises a plurality of locating pins configured to mate with a plurality of locating holes in the machine tray when die plate is in the second position.

22. An apparatus according to claim 9, wherein the punch plate comprises a plurality of locating pins configured to mate with a plurality of locating holes in the die plate when the punch is in the end position.

23. An apparatus according to claim 7, wherein the supply of sheet material comprises a first sheet of material and a second sheet of material running parallel to one another, and wherein the array of protrusions of the punch preferably comprises multiple rows of protrusions, each row being configured to punch a different sheet of material.

24. (canceled)

25. An apparatus according to claim 23, wherein the tensioning system comprises a pair of bobbins and a plurality of rollers configured to feed the first and second sheets of material through the punch and to generate tension in the tensioned portion of sheet material.

26. A method of forming a cut portion of sheet material and locating said cut portion of sheet material in a component for use in a delivery system, the method comprising:
supplying a continuous sheet material via a reel;
tensioning a portion of the sheet material via a tensioning system;
cutting said cut portion of sheet material from the tensioned portion of sheet material via a punch, and
locating said cut portion of sheet material within the component for use in a delivery system.

27. A method according to claim 26, wherein the method comprises moving the tensioning system from a first position to a second position, and wherein the method preferably comprises a second cutting step once the tensioning system has been moved from the first position to the second position.

28. (canceled)

29. A method according to claim 26, wherein cutting said cut portion of sheet material from the tensioned portion of sheet material comprises actuating a punch in a vertical plane between a start position, in which a punch plate is spaced from the tensioned portion of sheet material, and an end position in which the punch plate is configured to cut the tensioned portion of sheet material.

30. A method according to claim 26, wherein the method comprises clamping the tensioned portion of sheet material between a clamp plate and a die plate.

31. (canceled)

32. A method according to claim 30, wherein the method comprises actuating the die plate and clamp plate in a vertical plane in a direction towards the machine tray such that the tensioned portion of sheet material is clamped prior to moving the punch plate into interfacing relation with the die plate.
